(19) United States
(12) Patent Application Publication
(10) Pub. No.: US 2016/0012451 A1
(43) Pub. Date: Jan. 14, 2016

(54) COMBINED APPLICATION PROGRAMMING INTERFACE AND DEVICE MANAGEMENT FOR REMOTE DEVICE DIAGNOSTICS AND MANAGEMENT

(71) Applicant: Verizon Patent and Licensing Inc., Arlington, VA (US)

(72) Inventors: Sankar Shanmugam, Dayton, NJ (US); Gayathri Chandrasekaran, Somerset, NJ (US); Joe Varghese, Neshanic Station, NJ (US); Petri Virkkula, Kendall Park, NJ (US); Brian Matthew White, Port Murray, NJ (US)

(21) Appl. No.: 14/328,159

(22) Filed: Jul. 10, 2014

(51) Int. Cl. G06Q 30/00; G06F 21/44; H04L 29/06; H04W 76/02

(52) U.S. Cl. CPC G06Q 30/016; H04W 76/023; G06F 21/445; H04L 63/0869

(57) ABSTRACT

A customer service system is described that uses a remote device diagnostic system to improve a customer's experience during a customer service call. Mobile device operating system application programming interfaces provide access to resources on a mobile device allowing an external customer service system to access device information. The customer service system utilizes a combination of application programming interfaces and a device management protocol to provide remote device diagnostics during a customer service call. For devices that support device management protocol, the customer service system uses application programming interfaces for retrieval of device parameters and uses device management for device parameter configuration. For devices that do not support device management, the customer service system uses application programming interfaces for device parameter retrievals, but does not provide capabilities for remote device parameter configuration.

### BACKGROUND

Every day mobile device customer service representatives receive calls from customers regarding problems with the customers' mobile devices. The mobile device customer service representatives are typically presented with a multitude of device related problems. Being able to quickly diagnose the issues and resolve them remotely is important to the customers and is a key to a positive customer experience.

A typical customer service session is started because a customer requests assistance of a customer service representative in addressing an issue the customer is having with their mobile device or their network service. For example, the mobile device customer may make a call to a special short code (e.g., 3 digits—“123”), which initiates a customer service session that connects the customer to an automated system and/or a customer service representative. During a typical customer service session, the customer may provide the customer identification, the customer telephone number (i.e., mobile device number (MDN)), device identifier (IMEI or ISMI), the model of the device and manufacturer, to a customer service representative and/or to a system used by the representative. Based on “symptoms” of the problem, the customer is experiencing, the customer service representative is presented with a “script” in a user interface to follow in order to identify (i.e. “troubleshoot”) the cause of the problem, and hopefully resolve the problem. If the problem is likely with the mobile device, the troubleshooting often involves an interaction between the customer and the customer service representative during which the customer is asked to manually change different operating or device configuration parameters in the mobile device to assist in identifying and/or resolving the problem.

This interaction between the customer service representative and the customer may be time consuming and require the customer to perform various changes to mobile device settings, verbally provide long strings of alphanumeric characters to the customer service representative, and the like. As a result, the customer, even when the problem is resolved, may indicate that the call was a negative experience due to the time it took for the issues to be resolved. Also, any errors made during this exchange with the representative can be very frustrating to the customer. In order to assist both the customer and the customer service representative in quickly resolving the customer's mobile device problem, a set of protocols were developed.

The Open Mobile Alliance (OMA) Device Management (DM) working group and the Data Synchronization (DS) working group have defined a device management protocol (DM) that could overcome some of the differences among devices and provide a unified client/server interface to device management. The unified interface allows for a more streamlined and efficient “script” for a customer service representative to follow when troubleshooting a device. The unified interface also reduces the amount of manual tasks that a customer has to perform with the mobile device. However, not all devices available in the market today support DM, and, as a result for these devices, the unified interface is not always available. As a result, the customer service representative at times has to follow prior “scripts” requiring manual inputs from the customer.

The device manufacturers (i.e., OEMs) that do install OMA DM when manufacturing mobile devices typically implement a DM client that is packaged with OMA DM firmware on each mobile device. The OMA DM client interacts with a OMA DM server to provide remote device management. The OMA DM protocol specifies exchange of data packages during a session, each data package may consist of several messages, and each message may in turn consist of one or more troubleshooting commands. The OMA DM server initiates the troubleshooting commands and the OMA DM client is expected to execute the commands and return a troubleshooting result via a reply message.

However, the use of OMA DM for device management has limitations. For example, device manufacturers may install outdated versions of the OMA DM firmware on devices, or even different versions of OMA DM firmware in the same device make and model. In addition, OMA DM firmware updates happen very infrequently and the time to market for DM-based solutions are typically very long (typically 2 years). Furthermore, while an OEM may install OMA DM on the mobile device, it is unknown whether the OMA DM firmware conforms with the OMA DM device requirement standards. The differences in firmware versions of the OMA DM clients along with varied levels of conformance to the DM device requirement standards by the OEMs makes it difficult to purely rely on OMA DM for device management and troubleshooting a device.

In addition, use of the OMA DM protocol for all communication between the equipment of the customer service representative and the mobile devices suffers from a latency problem. In order to establish a customer service session, a mobile device must be authenticated to the customer service system. The authentication process requires the exchange of mobile device and/or user credentials that are exchanged by the transmission of short messaging system (SMS) messages. The authentication process may take some time. During the customer service session, it is common for the customer service representative to issue a variety of commands to the device for diagnosis and look for a resolution within a short period of time. The OMA DM protocol specifies an exchange of data packages during a customer service session, and each package includes several messages. Each message may include one or more commands. A customer service session may be closed after processing all of the one or more commands. For example, at the beginning of a troubleshooting session, the OMA DM server initiates all of the one or more commands; and the OMA DM client is expected to execute the one or more commands, return a result reply message. Upon receipt of the reply message, the customer service session between the customer service system and the mobile device is closed (i.e., “torn down”). However, if further action is necessary, a subsequent customer service session must be established. In order to establish the subsequent customer service session, the mobile device must re-authenticate with the customer service system, which, as mentioned, requires the exchange of device session authentication credentials via SMS messages. As a result, if the customer service representative needs to perform multiple troubleshooting steps to resolve a customer's problem, delays occur because of the repeated re-establishment of a customer service session.

Other solutions utilize a diagnostics application on the mobile device. However, these diagnostics apps may not be very robust. A few mobile device parameters useful for diagnostic tools may be obtained using operating system (OS) (e.g., Android®) open application programming interface (API) solutions (“open” meaning that any computer application (e.g., the diagnostic application) from a third-party, an OEM, a mobile network operator (MNO) or other vendor may use the OS open API).

Using the current versions of OS open API, the current remote diagnostic tools that interact with the diagnostics application on the mobile device have a very limited ability to diagnose and resolve device issues due to the limited device parameter access of the OS Open API protocol.

Furthermore, any configuration changes on the mobile device that are to be made via a diagnostic tool using the OS Open API requires elevated privileges on the device side which gives rise to security concerns.

As a result, a need exists for more insight into the configuration of the mobile device with regard to the device management capabilities of a mobile device and use of the configuration information by customer service representatives to improve the customer experience during a customer service call.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 illustrates a mobile device configured to utilize an example of the remote diagnostics system described herein.

FIG. 2 illustrates a high-level functional block diagram of an example of a customer service system.

FIG. 3 is a flowchart of an example of a customer service process.

FIG. 4A illustrates an example of a full featured customer service representative user interface.

FIG. 4B illustrates an example of an expanded field of the full featured customer service representative user interface.

FIG. 4C illustrates an example of other expanded fields of the full featured customer service representative user interface.

FIG. 5 illustrates an example of a reduced feature customer service representative user interface.

FIG. 6 is a high-level functional block diagram of an exemplary touch screen type mobile station as may utilize the customer service system through a network/system like that shown in FIG. 1.

FIG. 7 is a simplified functional block diagram of a computer that may be configured as server, for example, to function as the device management server, remote device diagnostics server, customer service center server, or database server in the system of FIG. 2.

FIG. 8 is a simplified functional block diagram of a personal computer or other work station or terminal device.

### DETAILED DESCRIPTION OF EXAMPLES

In the following detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

The various examples disclosed herein relate to a remote device diagnostic system of a customer service system that utilizes a combination of application programming interfaces (APIs) to access device diagnostics and a device management protocol client executing on a device. For devices that support the device management protocol, depending on the detected firmware version, the remote diagnostic system uses APIs and device diagnostic applications for retrieval of device parameters and uses the device management for device parameter configuration. For devices that do not support device management, the remote diagnostic system uses the APIs for device parameter retrievals, but does not provide remote device parameter configuration.

Using the combination of APIs and device management, the disclosed examples use a pre-fetch feature (facilitated by the APIs) that is integrated with the Interactive Voice Response (IVR) system, which is the system that initially greets a customer in a customer service system. For example, when a customer calls the customer service system, the IVR system will inform the diagnostic backend servers of the call from a particular mobile device. The diagnostic backend servers, in turn, send a wireless application protocol (WAP) push message to the particular mobile device to start a diagnostics device API and a device management diagnostic session between the mobile device and a customer service server. During the initial startup of the diagnostic session, the server obtains information from the device as well as from other resources, such as a database server, to determine the level of automated diagnostics that may be performed on the mobile device. This combined usage of the API mobile device parameter retrieval to potentially perform a device management diagnostics is advantageous because it provides a customer service representative with advanced knowledge of mobile device parameters that are configurable by the device management diagnostic tool (via a customer service representative user interface) in advance to entering a diagnostic session management flow with a customer.

Furthermore, to improve response time during a customer service session, the device management session is made persistent throughout the diagnostic session with the customer. The persistent device management session eliminates, for example, the need for the diagnostics server to issue a confirmatory mobile message (i.e. a short messaging system (SMS) message) to the device every time upon the receipt of a UI command (e.g., a confirmation by the diagnostics program). The persistent customer service session also eliminates the need for the diagnostics server to perform a device management session authentication for each command. Examples of the API include the OS Open API and an example of the device management protocol includes the OMA DM protocol, both of which were discussed above. Of course, other APIs or DM protocols may be used to provide the functions, or be implemented in the devices or systems of the examples described herein.

Reference now is made in detail to the examples illustrated in the accompanying drawings and discussed below.

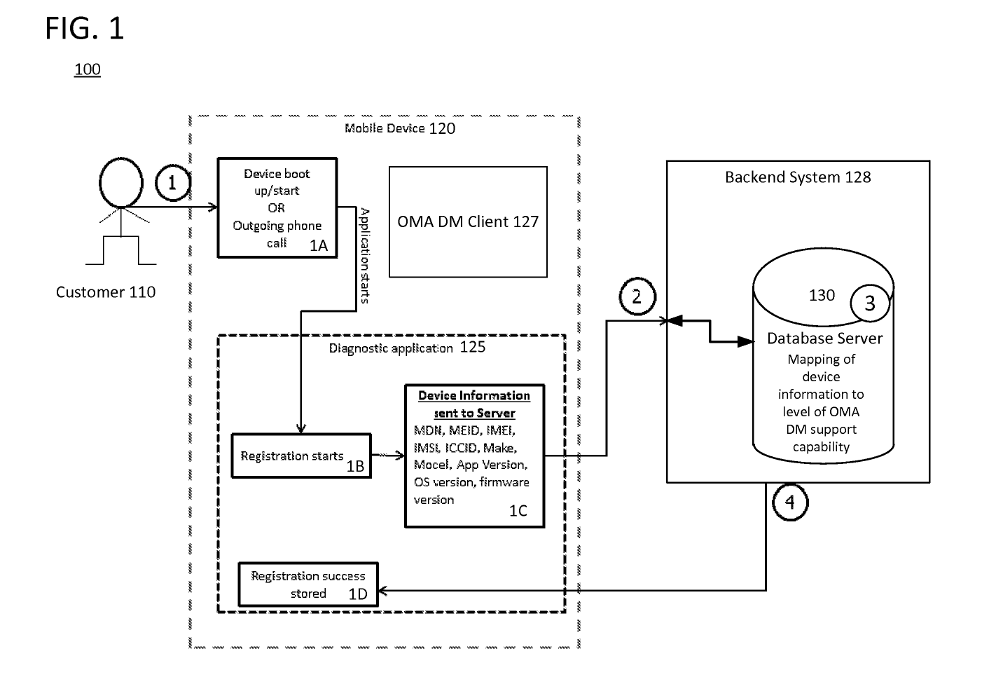

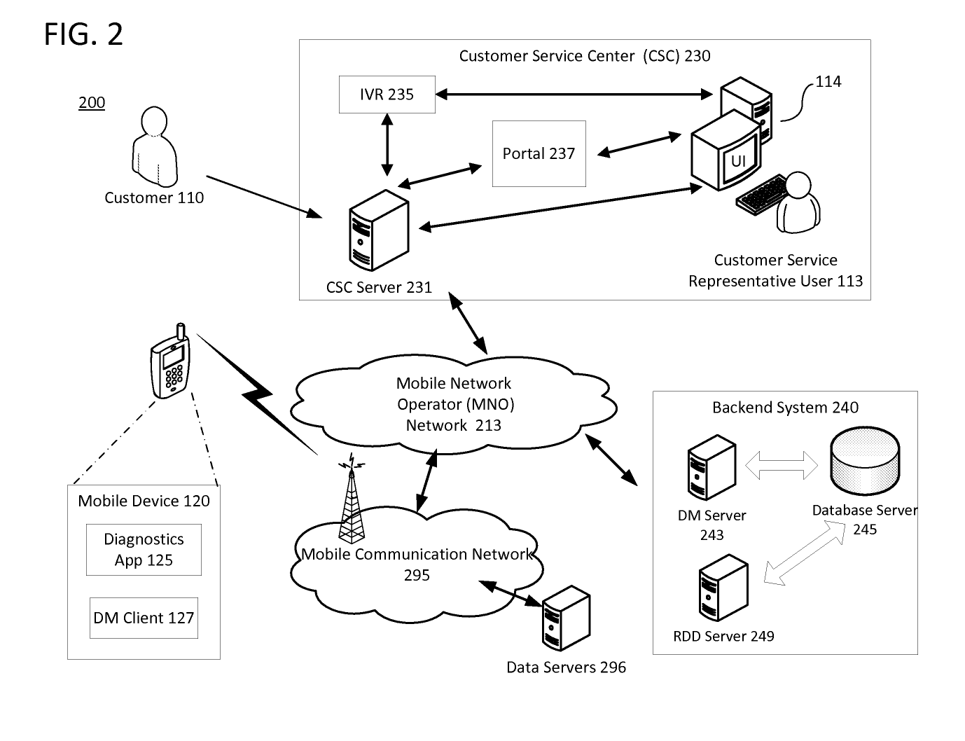

FIG. 1 illustrates a mobile device configured to utilize an example of the remote diagnostics system described herein. The remote diagnostics system 100 performs the diagnostic functions using a device diagnostic application 125 that communicates with a database server 130. The database server 130 that may be a server in a backend system 128. The server 130 may provide a customer service system (described in more detail with reference to FIG. 2) database services and may facilitate the storage of data used by the customer service system. The diagnostics application 125 installed on the mobile device 120 is executed by a processor (not shown in the current figure) of the mobile device 120. The device diagnostic application 125, via the API (such as an OS Open API), accesses device information of the mobile device 120 for use in the diagnosis of operational problems with the mobile device 120. The device information may include one or more of the MDN, the Mobile Equipment Identifier (MEID) (for 3G systems), the International Mobile Station Equipment Identity (IMEI for 3G systems), International Mobile Subscriber Identity (IMSI for LTE systems), integrated circuit card identifier (ICCID), Make, Model, device diagnostic application version, operating system version, firmware version. The device diagnostic application 125 provides the device information to the database server 130 on different occasions.

For example, at step 1, the device diagnostic application 125 may retrieve the device information and deliver the information in response to a pre-defined event. Whenever a pre-defined events occur, the diagnostics application 125 attempts to register the device information with a backend server, such as database server 130. A pre-defined event may include a device boot up, a device startup, a device restart, an outgoing telephone call, an outgoing text message, or the like. In this manner, the latest information regarding the mobile device is available when a customer service representative starts a remote diagnostic session. For example, a customer 110 installs the device diagnostic application 125 on the mobile device 120. In response to the installation, the device diagnostic application 125 may request a reboot of the mobile device (Step 1A). Alternatively, a pre-defined event may be an outgoing phone call, when a user changes a configuration parameter, such as a modification of Wi-Fi state, a modification of Bluetooth state, modification of the network state, e.g., change of access point name, or the like, of the mobile device.

Alternatively or in addition, at step 1, in response to an input from customer 110 instructing or requesting the mobile device to perform one of several pre-defined events, such as a device boot up, device start, device restart or an outgoing call (Step 1A), the device diagnostic application 125 begins a registration process (Step 1B). Such a pre-defined event may occur prior to the customer 110 attempting to contact customer service. A first step of the registration process may be to check a diagnostics status memory (not shown) of the mobile device 120 to determine if the mobile device 120 is already registered with a customer service system via a database server 130. For example, if the mobile device 120 has already been registered with the database server 130, a flag may be set in the diagnostics status memory.

In response to the occurrence of the pre-defined event and the registration flag in the diagnostics status memory not being set, the device diagnostic application 125 retrieves the device information from the device memory (not shown), such as that mentioned including one or more of MDN, MEID, IMEI, IMSI, ICCID, the mobile device make, the mobile device model, the device diagnostic application version, OS version, and the device management firmware version (e.g., DM firmware).

The mobile device 120 establishes an over-the-air communication connection with a customer service system (not shown in the current figure) that communicates with the database server 130. The retrieved information is sent (Step 1C) to the database server 130 in the form of a registration request for registering the mobile device 120. The database server 130 uses the provided information to identify (i.e. map) a level of device management support capability that is available from the mobile device 120. For example, the version value of the device management firmware (e.g., DM firmware) may indicate to the database server 130 a certain level of device diagnostic capabilities, the device diagnostic application version value may indicate a different level of diagnostic capabilities, and the MDN may allow the system to determine whether the customer 110 has subscribed to enhanced diagnostics services or the like. The other device information may also indicate different levels of device management support capabilities of the mobile device 120. The database server 130 maintains a mapping of this information to the level of device management support capability of the device. The mapping of the information may be stored by the database server 130 of the customer service system for later use by a customer service representative of the customer service system.

Upon a successful identification of the level of device management support capability that the mobile device 120 is able to receive, the database server 130 may return a message (at step 4) indicating that the registration of the mobile device 120 information with the database server 130 of the customer service system has been successful. In response to receiving the “successful registration” indication, the device diagnostics application 125 may set a flag that informs the processor that the mobile device 120 has been registered with the database server 130 (Step 1D). As a result, at the occurrence of another pre-defined event, the mobile device 120 processor checks the flag to determine whether to proceed with a registration start process. In other words, the database server 130 sends back a registration confirmation and the device diagnostic application 125 saves a “Success” flag in a memory, such as a diagnostic status memory, of the mobile device 120 so that the mobile device 120 does not needlessly repeat the registration next time a pre-defined event occurs. Upon receipt of the registration confirmation, the mobile device disconnects from the established over-the-air connection with the customer service system.

Alternatively, the database server 130 may return an indication that the registration was a failure, and, in response to which, the mobile device 120 processor may make another attempt at registering the mobile device 120. Alternatively, the mobile device 120 processor may wait until another pre-defined event occurs or until a later time and then attempt to re-register.

As another example, the mobile device will register again if some information in the mobile device is changed, in which case the “registration success” flag may be un-set by the diagnostics application 125. In a specific example, the subscriber identification module (SIM) card or universal integrated circuit card (UICC) may be changed or firmware may be updated. The diagnostics application 125 may perform status checks of certain parameters, such as a device identifier (e.g., MDN, MEID, IMSI), a UICC/SIM identifier (e.g., ICCID), firmware (e.g., firmware version), diagnostic application version and the like of the mobile device 120. The status checks may be performed periodically, or during the occurrence of a pre-defined event, such as at time of boot up of the mobile device, restart of the mobile device, or at the indication of an outgoing call (e.g., a selection of a telephone application key/icon on a user interface).

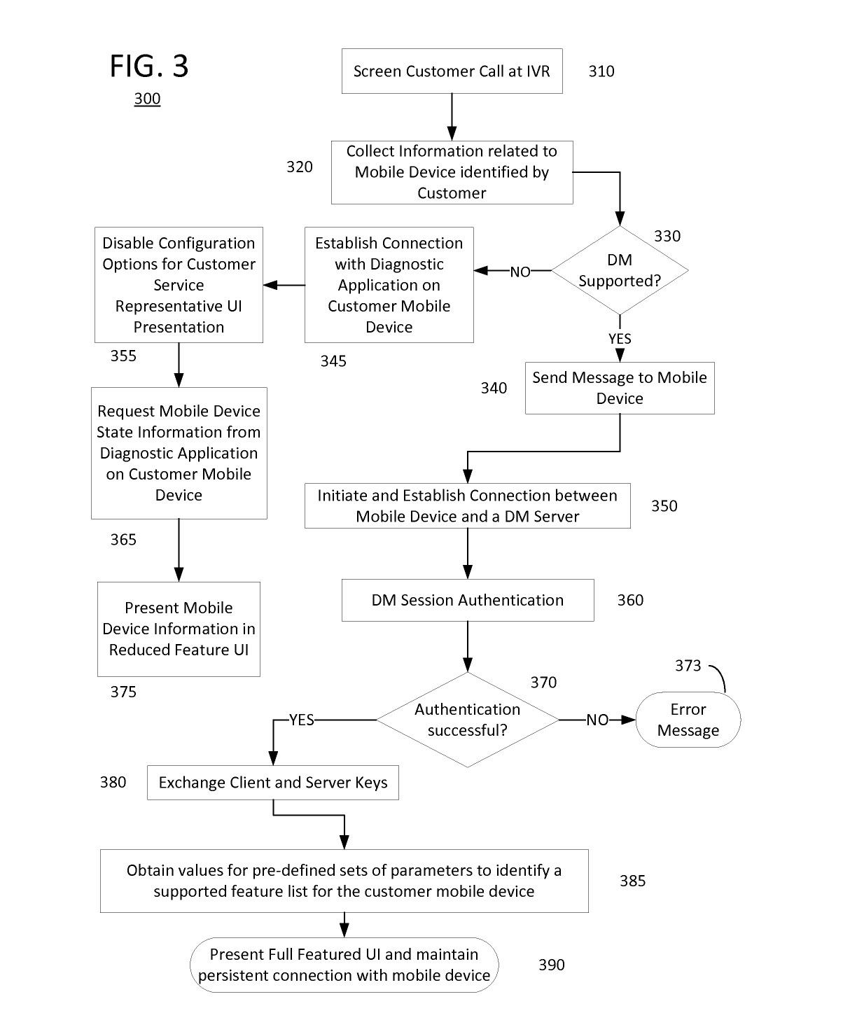

The registration, as shown in steps 2-4 of FIG. 1, of the mobile device 120 with the database server 130 provides the database server 130 of the backend system 128 with the information needed for improving a customer service experience for the customer 110 should the need for customer service arise. As explained in more detail with reference to FIG. 3, in response to a request containing, for example, the device information, the database server 130 identifies whether device management-based diagnostics are supported by the mobile device 120 or not. If supported, the DM client 127 assists in the management of the device management-based diagnostics by a customer service center (described in more detail with reference to FIGS. 2 and 3). The device management-based diagnostics provide services that allow a customer service representative to remotely access, after obtaining customer permission, a mobile device function and, with customer confirmation, change a configuration parameter associated with the mobile device function. For example, the device management firmware version of the mobile device 120 and OS version may provide an indication to the customer service representative the extent to which the customer service representative may access the configuration parameters of the device. Depending, for example, on the device management firmware version, the customer service representative may have complete access to all device functions identifiable by the configuration parameters. Alternatively, the device management firmware version may only cause only a subset of the device functions identifiable by the configuration parameters to be accessible via the customer service representative interface. Otherwise, if device management-based diagnostics are not supported, the diagnostics application 125 assists in the management of diagnostics by a customer service center. In the unsupported case, the customer service representative may request that the customer perform the configuration changes. In other words, the customer service representative may lead the customer 110 through a “script” to coach the customer 110 during the modification of the appropriate configuration parameters that are expected to resolve the customer's 110 problem. Thus, the customer 110 makes the changes to the configuration parameter while the customer service representative provides instructions during the call.

FIG. 2 illustrates a high-level functional block diagram of a customer service system for implementing examples of the disclosed subject matter.

A customer service system 200 may include a customer service center 230, a backend system 240, a mobile network operator (MNO) network 213, and a mobile communications network 295. At least one mobile device 120 is engaged by the customer service system 200 in response to a request from a customer for customer service.

The mobile device 120 is a voice and data communication device that may receive voice and data communication services from a MNO (such as Verizon®, AT&T® and the like) that provides the mobile communications network 295. The configuration parameters of the mobile device, such as Wi-Fi configuration settings, Bluetooth configuration settings, network settings and the like, may be modified via a DM client 127 (e.g., an OMA DM client) installed on the mobile device 120. Of course, a different device management client that provides similar capabilities and/or functionality as the described DM client 127 may be installed on the mobile device 120.

The mobile communications network 295 may be a wireless voice and data communications network through which mobile devices, such as mobile device 120, communicate with one another and with various servers, such as data servers 296. A data server 296 may provide different data content, such as websites (news, educational information and the like), videos, audio, gaming and other media. A mobile device customer, such as customer 110, may be a subscriber to services provided by a MNO that may provide the mobile communications network 295. The MNO may also have a private network, such as MNO network 213, over which the MNO conducts business (e.g., related to the operations of the MNO) as well as provides support services for the mobile communications network 295. For example, the customer service center 230 may communicate with other components (e.g., customer billing system, employee intranet, the backend system 240 and the like) of the MNO via the MNO network 213.

The customer service center (CSC) 230 may be provided by the MNO, such as the MNO that provides the MNO network 213, which provides voice and data communication services to the mobile device 120. The CSC 230 may include, for example, a system of servers, such as CSC server 231, configured to receive a large number of telephone calls. A first point of contact for customers with the customer service center 230 includes the Interactive Voice Response (IVR) system 235. The CSC server 231, other servers (not shown) and switching components connect the received calls to the IVR 235 that facilitates the connection of the customer 110 to a customer service representative 113, if necessary, based on customer 110 responses to specific queries, best equipped to handle the customer's 110 call. The IVR system 235, for example, is an automated system (e.g., implemented with a voice recognition capability or other user response system (e.g. keypad key presses)) that presents different questions to the customer 110 regarding the reasons why the customer 110 contacted the customer service center 230. In response to the customer 110 inputs in response to the presented questions, the IVR system 235 may be able to address the customer's 110 problem without the involvement of a customer service representative 113. For example, the customer 110 may be unable to make a call using the mobile device 120, and based on targeted questioning by the IVR system 235 of the customer 110, the IVR system 235 may determine that the customer 110 has a billing issue related to the mobile device 120. Of course, other issues, such as network connectivity, software versions and other information may be addressed by the IVR system 235, but more technically complex issues and/or other issues may require the assistance of a customer service representative 113. In the present example, the customer 110 may request customer service for a mobile device 120 that has installed thereon a diagnostics application 125 and a DM client 127.

The customer service center 230 may provide a portal 237, which provides a graphical user interface on a customer service representative terminal 114 that allows the customer service representative (i.e., a user) 113 to access information via the CSC server 231 in servers and databases maintained by the backend system 240, and also modify information related to the mobile device 120. The user interface via the portal 237 provides a customer service session management flow (i.e., “script”) to the customer service representative to follow during the customer service session. Through the portal 237, the customer service representative is able to obtain additional information from the backend system 240 to perform their customer service function. For example, the customer service representative is able to enable and disable configurations (described in more detail with respect to FIG. 3) on the mobile device 120 as well as obtain mobile device information via the backend system 240.

The backend system 240 may include a DM server 243 (i.e., a device management server), a remote device diagnostics (RDD) server 340, and a database server 245 as well as connections to the mobile communications network 295 and the MNO network 213. The backend system 240 communicates with the CSC 230 via the backend connections to the MNO network 213, and communicates with the mobile device 120 via the backend connections to the mobile communication network 295. If the mobile device 120 is configured to support the DM protocol, the DM server 243 provides device management functions (e.g., OMA device management functions) that allow a customer service representative 113 to enable and disable configurations on the mobile device 120. For example, the DM server 243 is configured to exchange messages in a DM session defined by the DM protocol with a DM-compatible mobile device 120. The DM session communications between a DM client and DM Server uses “Secure Sockets Layer” (SSL) or “Transport Layer Security” (TSL) protocol over HTTP. Based on the DM diagnostic version number retrieved from the DM client, the DM server 243 identifies the set of diagnostic information that can be retrieved or configured using DM techniques via the DM protocol messages. The DM server 243 is then able to retrieve mobile device information related to the identified set of diagnostic information, and modify (e.g., enable or disable) device settings related to one or more of provisioning the device, device configuration, software upgrades and fault management. For example, a customer service representative 113 is presented with some or all of the retrieved mobile device information, which the customer service representative 113 is then able to modify by either enabling or disabling features related to the set of diagnostic information and retrieved mobile device information.

The RDD server 249 is configured to access the mobile device 120 via the mobile device API (e.g., the OS Open API) and the diagnostics application 125 to obtain a subset of configurable device settings accessible through the mobile device API (i.e., not all configurable device settings on the mobile device 120 are available for retrieval by the RDD server 249). The diagnostics application 125 on the mobile device 120 reads and reports mobile device state information (e.g., Wi-Fi ON/OFF, global communication mode, or other state information).

In operation, the customer service system 200 may perform a number of different customer service-related processes. FIG. 3 provides a flowchart of an example of a customer service process according to examples disclosed herein. The customer service process 300 is initiated because a customer, such as customer 110, has a problem, or, is having difficulty with their mobile device, such as mobile device 120. In response to the problem or difficulty, the customer 110 calls into a customer service center, such as customer service center 230, that is provided by the customer's 110 MNO. In the following discussion of the example of FIG. 3, it is presumed that the mobile device 130 has previously registered with the backend system 240 as described above.

In an initial customer service call, a customer 110 calls and is connected to the customer service center 230. At 310, the IVR system 235 initially screens the customer's 110 call to ascertain the reason why the customer 110 is calling the customer service center 230. In response to the questions, the IVR system 235 expects to receive either voice or keystroke inputs from a customer 110 via the device (e.g., mobile device 120, home telephone or home computer) that the customer is using to contact the customer service center 230 or from a customer's 110 telephonic device (e.g., mobile device). Said differently, the IVR system 235 may receive calls or have contact with devices (e.g., home telephone or laptop computer) that are not the mobile device that will be diagnosed via the described diagnostic examples. For example, if a user is unable to access their mobile device, the user is able to contact the IVR system via another device to obtain device management assistance with their mobile device. Typically, during an interaction with the IVR 235, a customer 110 identifies the mobile device 120 that is the reason for the customer service request (i.e. call) by confirming the MDN of the mobile device, or another mobile device that is the subject of the customer service call (e.g., a mobile device that is used primarily by the customer's 110 child). In either case, a mobile device is identified. Of course, other information may be used to determine the authenticity of the customer 110 and also to uniquely identify the mobile device that is the subject of the customer service call. For example, the MDN, IMSI, IMEI or other identifier may be provided to the IVR system 235 by the customer 110.

Upon receipt of some information that uniquely identifies the mobile device, the backend system 240 collects information from one or more databases, for example, via the database server 245, that completely and uniquely identifies the customer 110, the customer's 110 identified mobile device 120, and a SIM/UICC card of the customer 110. In the presently disclosed examples, the IVR system 235, in response to receiving the customer 110 mobile device identifier, triggers the backend system 240 to perform a device capability check (at decision block 330). The backend system 240 accesses a data storage, such as database server 245, to determine the level of DM support capabilities of the customer's 110 identified mobile device 120, which is based on information received earlier (i.e., as described with respect to FIG. 1) during the registration of the mobile device 120 with the customer service system 200. This combination of information uniquely identifies the customer 110 to the customer service system 200. The check of DM support capabilities is performed using the device information, such as the mobile device identifier, obtained from the IVR system 235 during the initial customer 110 interaction against a mapping table containing the device information and level of DM support capability of the mobile device 120 is capable of supporting. Other checks may also be performed by the backend system 240, such as confirmation that the customer 110 is an authorized user of the mobile device whose MDN or other identifying information was input into the IVR system 235. At 330, a determination is made regarding the level of DM support that the identified mobile device is capable of providing to a customer service representative.

Also, at this time, the IVR system 235 may be transitioning the calling customer 110 from the IVR system 235 to a live, customer service representative 113 for resolution of the customer's 110 problem or difficulty. The preceding and the foregoing steps may be performed in the background as the transition of the calling customer 110 from the IVR system 235 to the customer service representative 113.

If the decision at 330, indicates that the mobile device is DM capable and also provides the level of DM support that the mobile device is capable of providing to the CSC 230. In response to an indication that “YES” the mobile device 120 is DM compatible and the level of DM support, the backend system 240 sends (at 340) a message, such as a WAP push or SMS message, to the mobile device 120. In response to the message (e.g., the WAP push message), the mobile device 120 (at 350) initiates a procedure to establish a connection between a DM client 127 on the mobile device 120 to the DM server 243. Also, at this time, the IVR system 235 is providing information to the backend system 240, which is constructing (or populating, if existing) a mobile device 120 parameter profile for presentation via a graphical user interface to a customer service representative 113. The mobile device 120 parameter profile may be maintained in a memory (not shown) accessible by the customer service representative 113 via portal 237 of customer service center 230.

Upon connection of the mobile device 120 to the DM server 243, the DM server 243 executes DM session authentication procedures (at 360). For example, the DM server 243 confirms that the DM client 127 is the authorized to interact with the DM server 243, and that the customer 110 and the identified mobile device 120 are associated with one another (i.e., the customer 110 is an authorized user or owner of the identified mobile device 120). A determination is made at 370 whether the authentication procedures are successful. If the authentication procedures are unsuccessful, an error message at 373 may be presented to the customer service representative 113 and on the identified mobile device 120, and the customer service center 230 may take remedial actions to determine the cause of the authentication failure. Alternatively, if the authentication procedures at 370 are successful, the process 300 proceeds to 380. At step 380, the DM client 127 and the DM server 243 exchange security keys and are kept in synchronization.

In addition, upon a successful authentication, or during the authentication process, the backend system 240 provides device information to the customer service center 230 based on the identified mobile device 120 identifying information (385). For example, for the device with DM based diagnostic capability determined at 330, the DM server 243 will communicate with the mobile device 120 using the DM protocol. The DM server 243 is configured send messages, such as a DM Package #0 Notification WAP push message, to the mobile device 120 requesting that the mobile device 120 DM client 127 to start a DM session. To provide security to the communications, the DM session communications between DM Client and DM Server uses “Secure Sockets Layer” (SSL) or “Transport Layer Security” (TSL) protocol over HTTP. Based on the DM diagnostic version number retrieved from the DM client 127, the DM server 243 will identify a set of diagnostic information which can be retrieved or configured using DM from the mobile device 120.

According to the DM protocol, a number of messages are typically exchanged between the DM server 243 and the DM client 127 on the mobile device 120. Typically, a DM session experiences latency issues due to the round-trip data package communication delays between the DM server 243 and the DM client 127 in which a confirmation message was sent to the device whenever a customer service representative 113 UI command was received, and a need to perform a device management session authentication for each command. The presently disclosed examples alleviate the latency issues by retaining a persistent connection throughout the diagnostic session.

For example, the DM server 243 does not close a session (by sending a DM Package-4 with no commands) in response to receiving a response from the DM client 127 on the mobile device as is typical. Instead, the DM server 243 waits until the diagnostic session with the customer is clearly ended. For example, the customer service representative 113 terminal may issue a command upon detecting that a call connection with the customer 110 is closed or disconnected. The DM client 127 and DM server 243 are subject to a timer that is set to a predetermined time out period. As a result, the DM client 127 and DM server 243 will not wait indefinitely for a subsequent exchange of a data package, so, in the absence of real commands from the customer service representative 113 UI, the DM server 243, according to the disclosed examples, populates a response message with dummy “GET” commands that extends the DM session with the mobile device 120. As a result, the need for re-issuing, for example, an OMA DM Package#0 WAP Push message or the like, to the mobile device 120 upon the receipt of customer service representative 113 UI command and having to perform DM session authentication is eliminated. Accordingly, the connection between the DM server 243 and the mobile device 120 remains persistent for a longer duration than a typical DM session.

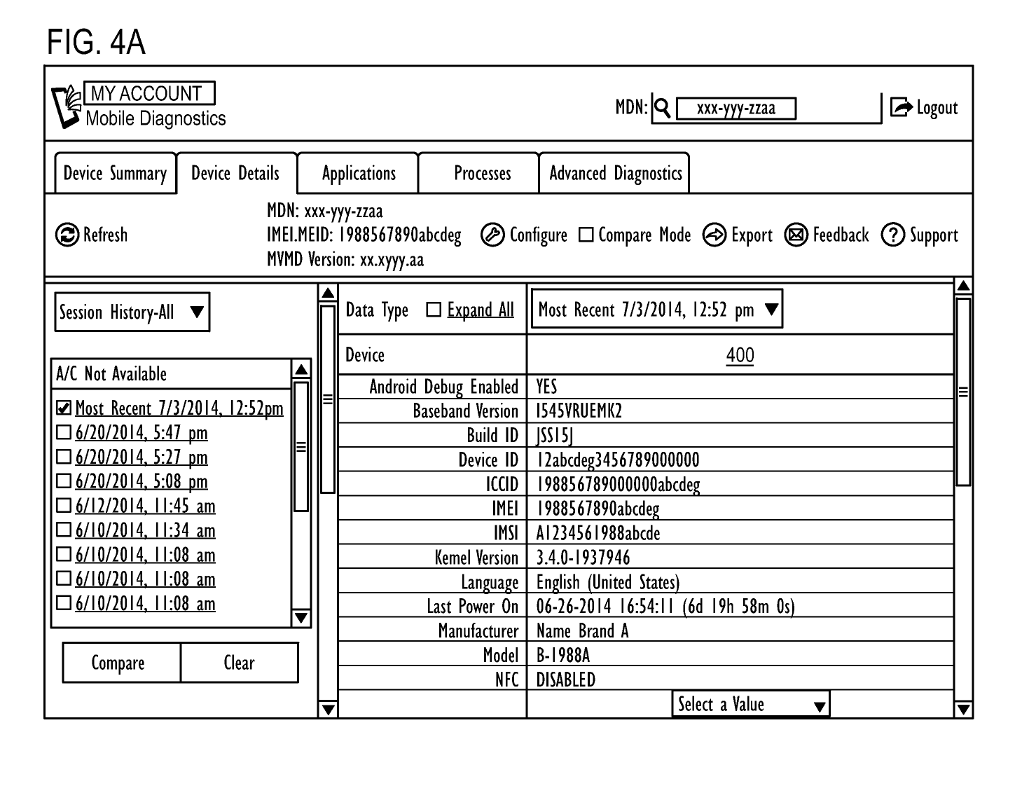

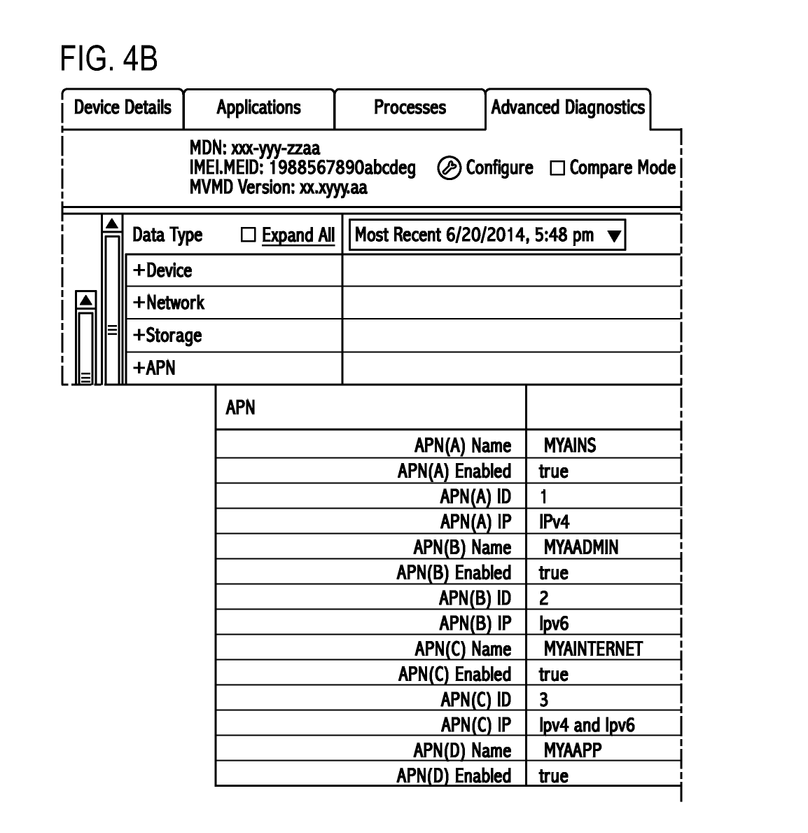

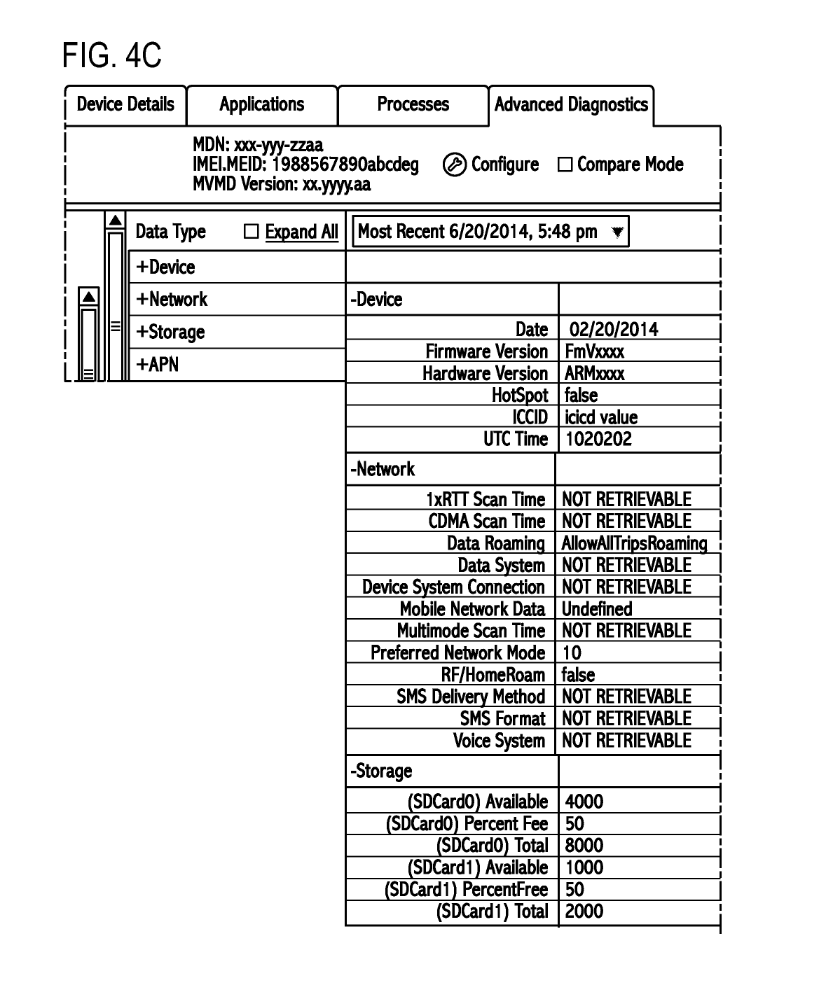

During the connection with the customer 110, the customer service representative 113 is presented with an DM, full-featured user interface (UI) (as shown in FIG. 2 and in more detail in FIGS. 4A-C) on a customer service representative 113 display device that presents in the DM UI, at 390, the device information, which may include predefined sets of parameters used to identify the DM-supported feature list for the identified mobile device 120. For example, the predefined set of parameters may be presented to the customer service representative 113 in a table format, such as that shown in FIGS. 4A-C.

The set of parameter values that are obtained and presented allow a customer service representative 113 to execute mobile device configuration changes through a DM client 127 interface on the mobile device 120. Examples of the mobile configurations that may be performed using the DM UI include modifications to the Wi-Fi State (e.g., turn ON/OFF the Wi-Fi radio, initiate a scan of Wi-Fi signals in the vicinity of the mobile device 120, or the like); modifications to the Bluetooth state (e.g., turn ON/OFF the Bluetooth radio, scan for Bluetooth signals in the vicinity of the mobile device 120, or pair with a specific Bluetooth device, or the like); or modifications to the network state, such as configure access point name parameters, enable/disable global mode, or Turn ON/OFF the long term evolution (LTE) radio, or the like.

These sets of parameters are presented in a DM UI (i.e. a full featured UI). Full featured meaning that a greater number of mobile device parameters may be presented if the mobile device 120 is DM compatible (regardless of the level of DM capability the mobile device is able to support as compared to the lesser number of device parameters that are presented to the customer service representative 113 for a mobile device that is not OMA compatible.

For example, FIG. 4A illustrates an example of a user interface generated based on a mobile device 120 parameter profile examples of the disclosed subject matter. The UI 400 presented in FIG. 4A is an example of a full featured UI generated in step 390 of FIG. 3. In the example of FIG. 4A, UI 400 provides a tabbed interface that allows the customer service representative move through different topics related to a device, such as Summary, Device Details, Applications, Processes and Advanced Diagnostics. The example UI is constructed based on device diagnostic information retrieved from the device using DM client 127 and the diagnostic application 125, which is stored in a database under control of the database server 130/245. If there are parameters that overlap when retrieved using both the DM client 127 and the diagnostic application 125, the DM server 243 may consider data retrieved via the DM client 127 as being accurate (i.e., superseding the diagnostic application 125 data) and the merged data presented to the customer service representatives 113 in the web portal 237 for diagnostic purpose. Also based on the mobile device 120 firmware version retrieved during initial wake up flow, the UI presented via portal 237 identifies the DM based diagnostic features and parameters (e.g., Wi-Fi, Bluetooth, GPS, network state and the like) supported by the mobile device 120 and accordingly enable/disable the diagnostic application option to the customer service representative 113. FIGS. 4B and 4C illustrate examples of expanded fields of the full featured customer service representative user interface. In particular, FIGS. 4B and 4C illustrate the Advanced Diagnostics menu and parameters provided by expanding the Advanced Diagnostic menu. The full feature UI 400 of FIGS. 4A-4C is illustrated as UI examples for purposes of discussion. Of course, other implementations or arrangements of the UI 400 may be used or implemented.

An advantage of determining the DM capabilities of a mobile device 120 prior to completing a connection to a customer service representative 113 to allow a more extensive, full featured UI presentation for a customer service representative 113 to be generated based on a mobile device 120 parameter profile. However, a reduced feature UI also is helpful, but does not include an option to allow a customer service representative 113 to configure a parameter.

With reference back to determination 330 of FIG. 3 in response to a “NO” determination, the customer service center 230 determines that the mobile device 120 (in this part of the example) does not support any level of DM, and the process 300 proceeds to 345.

At 345, since the device is not DM capable, the RDD server 249 via the OS Open APIs establishes a connection with the diagnostic application 125. In addition, an indication is provided to the CSC server 231 that configuration options in the user interface presented to the customer service representative 113 are to be disabled. Since the mobile device 120 is not capable of having configurations modified via the DM protocol, the option to configure the configurable parameters is disabled (355), in which case, a list of DM configurable parameters is not presented in a user interface to the customer service representative 113. An advantage being that the customer service representative 113 is able to immediately see the options available to him for solving the customer's 110 problem without having being presented with a number of unavailable options. To better understand the current status of the device, the RDD server 249 does request that the diagnostic application 125 fetch state information of the mobile device 120.

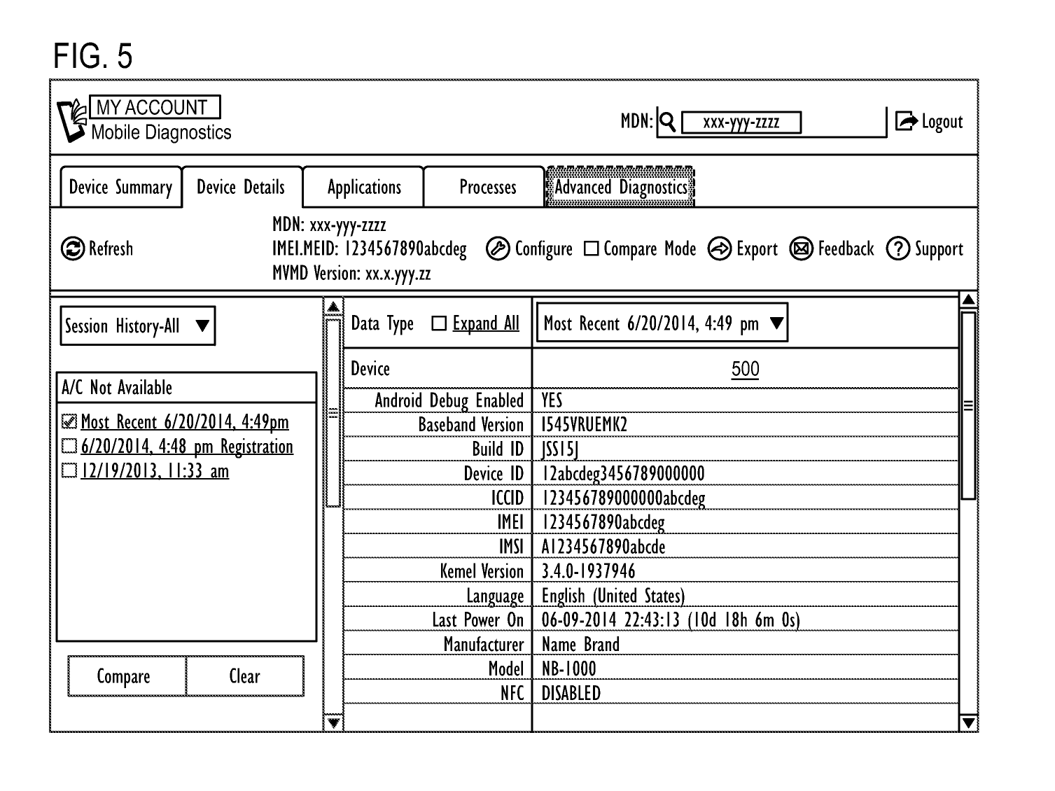

The fetched mobile device 120 state information is presented in a reduced feature UI presented to the customer service representative 113. FIG. 5 illustrates an example of a reduced feature UI generated based on examples of the disclosed subject matter. This UI is an example of a reduced feature UI generated at step 375 of FIG. 3. The reduced feature UI 500 presents the mobile device 120 parameters that are useful for the customer service representative 113 to conduct a customer service session flow. For example, the tabbed interface 500 allows the customer service representative move through different topics related to a device, such as Summary, Device Details, Applications, and Processes. Note that in this example since the mobile device 120 does not support device management, the Advanced Diagnostics tab is unavailable to the customer service representative. The parameters and values shown in FIG. 5 are the parameters and values that are accessible on the identified mobile device 120 via the diagnostics application 125. However, in response to the connection with the diagnostics application on the identified mobile device, the customer service representative's 113 ability to configure the presented parameters and parameter values is disabled (as shown at 355 of FIG. 3). In other words, the customer service representative 113 has no mobile device parameter configuration options that may be performed from the customer service representative's 113 UI when using the diagnostics application 125. The reduced feature UI 500 is illustrated as an example for purposes of discussion. Of course, other implementations or arrangements of the UI 500 may be used or implemented.

The above described examples illustrating combining of mobile device API based diagnostics with DM provide a benefit of reduced the time to market for the diagnostic capabilities since the remote diagnostic applications penetrate the market much faster than the DM client. In addition, the diagnostic application 125 can be used for device parameter retrievals in the absence of DM client 127. Furthermore, the combined usage of DM and mobile device API allows the customer service representatives 113 to support an increased percentage of an MNO's customer base more effectively, and provide a better customer service experience for the customers with devices that support DM since the customer service representative will have greater amount of device information and control over the remote device diagnostics features. Finally, the reduced latency in the customer calls addressing remote device diagnostics further improves the customer experience.

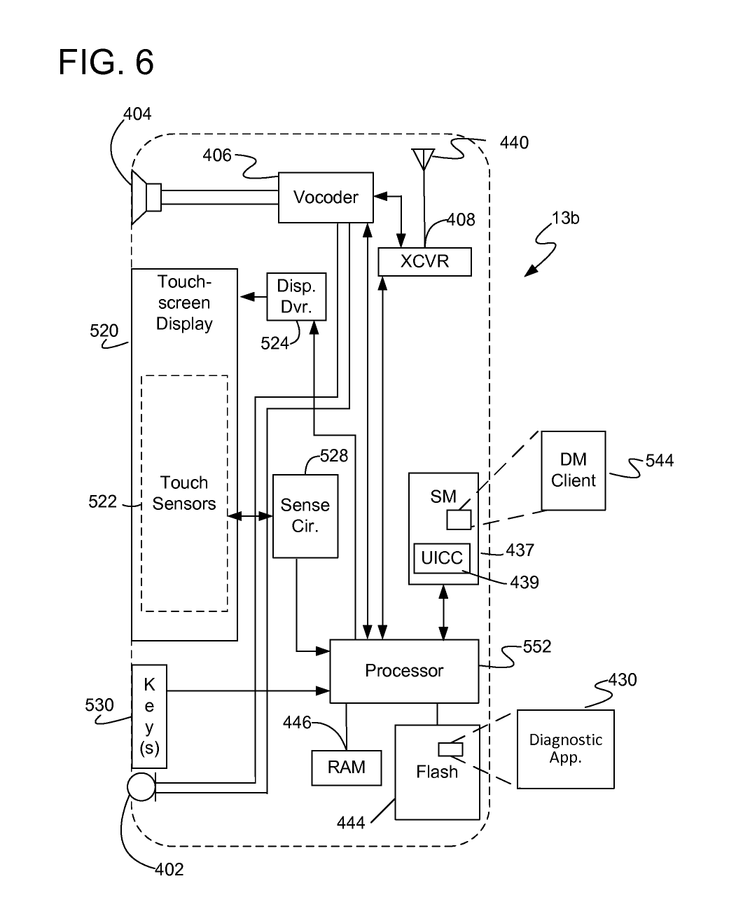

An example of a mobile device suitable for interaction with the CSC 230 and for implementing examples of the disclosed remote diagnostics is illustrated in FIG. 6. For purposes of such a discussion, FIG. 6 is a high-level functional block diagram of an exemplary touch screen type mobile device 13b as may utilize the remote device diagnostics system. Although the mobile device 13b of FIG. 6 may be a smart-phone or may be incorporated into another device, such as a personal digital assistant (PDA) or the like, for discussion purposes, the illustration shows the mobile station 13b is in the form of a handset. The handset embodiment of the mobile device 13b functions as a normal digital wireless telephone device. For that function, the station 13b includes a microphone 402 for audio signal input and a speaker 404 for audio signal output. The microphone 402 and speaker 404 connect to voice coding and decoding circuitry (vocoder) 406. For a voice telephone call, for example, the vocoder 406 provides two-way conversion between analog audio signals representing speech or other audio and digital samples at a compressed bit rate compatible with the digital protocol of wireless telephone network communications or voice over packet (i.e., Internet Protocol) communications.

For digital wireless communications, the handset 13b also includes at least one digital transceiver (XCVR) 408. Today, the handset 13b would be configured for digital wireless communications using one or more of the common network technology types. The concepts discussed here encompass embodiments of the mobile device 13b utilizing any digital transceivers that conform to current or future developed digital wireless communication standards. The mobile device 13a may also be capable of analog operation via a legacy network technology.

In order to run secure applications such as the DM client 127 of FIG. 2, there is a secure memory (SM) 437. In one example, the SM 437 is separate chip that includes a secure processor, a tamperproof storage and a memory, and is configured to communicate with applications executing on the processor 552 and to maintain the device parameters stored therein by the DM client 127. In another example, the SM 437 is a memory that is part of the system memory of the mobile device 13b, and is configured to maintain the enrolled templates stored therein by the DM client 127. The SM 437 may be a physically secure memory, a physical secure memory with a secure controller that may contain a matching algorithm, part of the system memory (less secure) with cryptography and obfuscation algorithms to help protect the enrollment templates (the processor 5522 may be configured perform these functions), or part of the system memory but the processor 552 may be in a secure mode (e.g., ARM Trust Zone®) to perform the encryption function and to keep the encryption process and keys secure. The SM 437 may also serve as the diagnostics status memory of the mobile device 13b that may be used to determine if the mobile device 13b is already registered with a server in the backend system 240.

For example, the diagnostic application and DM client that run on the secure memory (SM) 437 typically run on a Javacard operating system. The SM may include various account information, such as account number, user identification, a personal identification number (PIN), or the like for user verification and possibly account balance and/or transaction record information. The SM 437 may be used to decode credentials of devices. In various examples, the SM 437 may be part a UICC 439 or a separate SM-like memory card, such as a secure digital (SD) memory card, used for storing and accessing applications and data, such as diagnostic application and DM client, in a secure manner. The logic implemented by the processor 552 of the mobile device 13b configures the processor 552 to control various functions as implemented by the mobile device 13b. The logic for a processor may be implemented in a variety of ways, but in our example, the processor logic is implemented by programming for execution by the processor 552.

The transceiver 408 provides two-way wireless communication of information, such as vocoded speech samples and/or digital information, in accordance with the technology of the network 45. The transceiver 408 also sends and receives a variety of signaling messages in support of the various voice and data services provided via the mobile device 13a and the communication network. Each transceiver 408 connects through RF send and receive amplifiers (not separately shown) to an antenna 440. The transceiver may also support various types of mobile messaging services, such as short message service (SMS), enhanced messaging service (EMS) and/or multimedia messaging service (MMS).

A microprocessor 552 serves as a programmable controller for the mobile device 13b, in that it controls all operations of the mobile device 13b in accord with programming that it executes, for all normal operations, and for operations involved in the remote device diagnostics under consideration here. In the example, the mobile device 13b includes flash type program memory 444, for storage of various “software” or “firmware” program routines and mobile configuration settings, such as mobile directory number (MDN) and/or mobile identification number (MIN), etc. The mobile device 13b may also include a non-volatile random access memory (RAM) 446 for a working data processing memory. Of course, other storage devices or configurations may be added to or substituted for those in the example. In a present implementation, the flash type program memory 444 stores firmware such as a boot routine, device driver software, an operating system, call processing software and vocoder control software, and any of a wide variety of other applications, such as client browser software and short message service software. The memories 444, 446 also store various data, such as telephone numbers and server addresses, downloaded data such as multimedia content, and various data input by the user. Programming stored in the flash type program memory 444, sometimes referred to as “firmware,” is loaded into and executed by the microprocessor 552. For example, the flash type program memory 444 may store programming for implementing the DM client 127 of FIG. 1, and as well as programming for implementing the diagnostic application 430. The microprocessor 552 may access the programming in the flash type program memory 444 to execute the above-described remote device diagnostics functions. For example, the flash memory 444 configures the processor 552 so that the mobile device 13b is capable of performing various desired functions, including in this case the functions involved in the technique for obtaining and providing device information to the diagnostic application 430.

The microprocessor 552 serves as a programmable controller for the mobile device 13b, in that it controls all operations of the mobile device 13b in accord with programming that it executes, for all normal operations, and for operations involved in the remote device diagnostics under consideration here. In the example, the mobile device 13b includes flash type program memory 444, for storage of various program routines and mobile configuration settings. The mobile device 13b may also include a non-volatile random access memory (RAM) 446 for a working data processing memory. Of course, other storage devices or configurations may be added to or substituted for those in the example. Hence, outlined above, the mobile device 13b includes a processor, and programming stored in the flash memory 444 configures the processor so that the mobile device is capable of performing various desired functions, including in this case the functions involved in the technique for providing the remote device diagnostics. For example, the flash type program memory 444 may store programming for implementing the DM client 544, and as well as programming for implementing the diagnostic application 430. However, the DM client 544 may be stored in the SM 437 since the DM client 544 is capable of changing some device parameters that typically require higher levels of authorization than device parameters that may be manipulated by the diagnostic application 430. The microprocessor 552 may access the programming in the flash type program memory 444 to execute the above-described diagnostic functions.

The mobile device 13b of FIG. 6 may have a limited number of keys 530, but the user interface functions of the display and keypad are replaced by a touchscreen display arrangement. At a high level, a touchscreen display 520 is a device that displays information to a user and can detect occurrence and location of a touch on the area of the display. The touch may be an actual touch of the display device with a finger, stylus or other object, although at least some touchscreens can also sense when the object is in close proximity to the screen. Use of a touchscreen display as part of the user interface enables a user to interact directly with the information presented on the display. In addition to normal telephone and data communication related input/output (including message input and message display functions), the user interface elements (e.g., keys 530, touchscreen display 520) also may be used for display of menus and other information to the user and user input of selections, including any needed during presentation of a diagnostics application 125 menu. For example, if used to receive selections for reconfiguration of device parameters vial the diagnostic application, the user interface elements may respond to various inputs from a customer 110. In addition, the user interface elements may be used to generate mobile device 120 parameter change notifications (e.g., made during a DM diagnostics session) and receive the customer 110 confirmation that such a configuration change is accepted.

Hence, the exemplary mobile device 13b includes a display 520, which the microprocessor 552 controls via a display driver 524, to present visible outputs to the device user. The mobile device 13b also includes touch sensors 522. The sensors 522 are relatively transparent, so that the customer may view the information presented on the display 520. A sense circuit 528 sensing signals from elements of the touch sensor 522 and detects occurrence and position of each touch of the screen formed by the display 520 and sensors 522. The sense circuit 528 may provide touch position information to the microprocessor 552, which can correlate that information to the information currently displayed via the display 520, to determine the nature of user input via the screen.

The display 520 and touch sensor 522 (and possibly one or more keys 530, if included) are the physical elements providing the textual and graphical user interface for the mobile device 13b. The microphone 402 and speaker 404 may be used as additional user interface elements, for audio input and output, including with respect to the diagnostics application 430 and mobile device API (e.g., OS Open API) related functions.

The structure and operation of the mobile device 13b, as outlined above, was described by way of example, only.

As shown by the above discussion, functions relating to the remote device diagnostics, via a graphical user interface of a mobile device may be implemented on computers connected for data communication via the components of a packet data network, operating as a diagnostics application 430 or DM client 544 to access device information and/or transmit the device information for use in the remote device diagnostic system. Although special purpose devices may be used, such devices also may be implemented using one or more hardware platforms intended to represent a general class of data processing device commonly used to run “server” programming so as to implement the remote device diagnostics functions discussed above, albeit with an appropriate network connection for data communication.

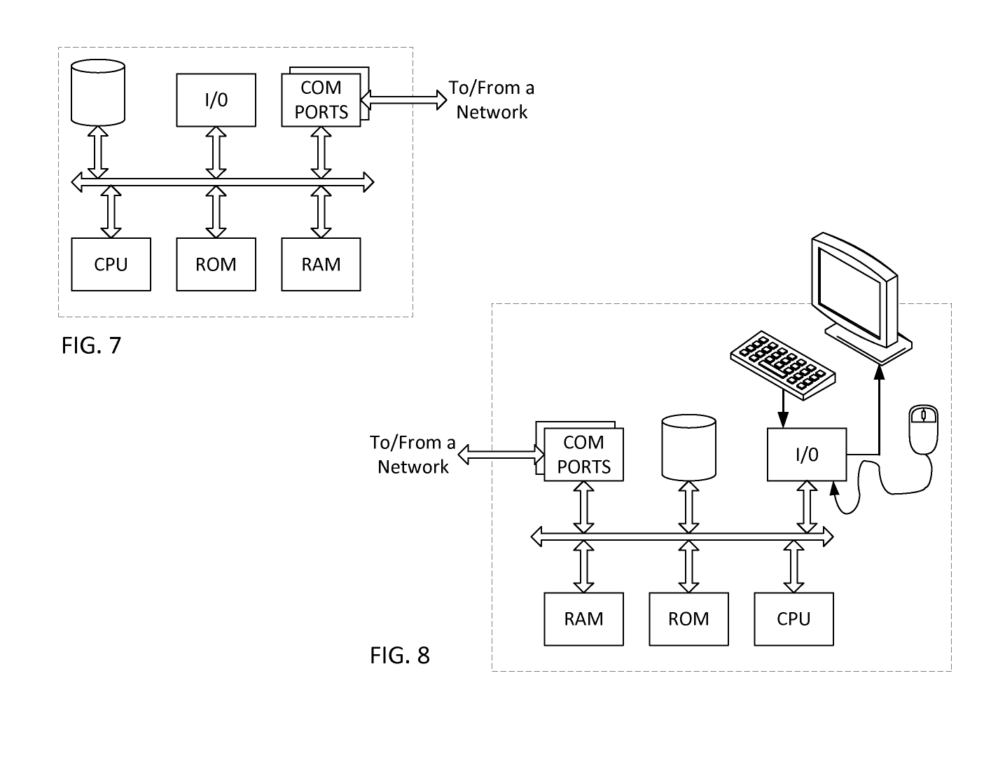

FIGS. 7 and 8 provide functional block diagram illustrations of general purpose computer hardware platforms. FIG. 7 illustrates a network or host computer platform, as may typically be used to implement a server. FIG. 8 depicts a computer with user interface elements, as may be used to implement a personal computer or other type of work station or terminal device, although the computer of FIG. 8 may also act as a server if appropriately programmed. It is believed that the general structure and general operation of such equipment as shown in FIGS. 7 and 8 should be self-explanatory from the high-level illustrations.

A server, for example, includes a data communication interface for packet data communication. The server also includes a central processing unit (CPU), in the form of one or more processors, for executing program instructions. The server platform typically includes an internal communication bus, program storage and data storage for various data files to be processed and/or communicated by the server, although the server often receives programming and data via network communications. The hardware elements, operating systems and programming languages of such servers are conventional in nature. Of course, the server functions may be implemented in a distributed fashion on a number of similar platforms, to distribute the processing load.

A computer type user terminal device, such as a PC or tablet computer, similarly includes a data communication interface CPU, main memory and one or more mass storage devices for storing customer service representative data and the various executable programs (see FIG. 8). For example, the computer type user terminal device may be configured to implement a customer service representative terminal 114 and the customer service representative UI as shown in FIG. 2. A mobile device type user terminal may include similar elements, but will typically use smaller components that also require less power, to facilitate implementation in a portable form factor. The various types of user terminal devices will also include various user input and output elements. A computer, for example, may include a keyboard and a cursor control/selection device such as a mouse, trackball, joystick or touchpad; and a display for visual outputs. A microphone and speaker enable audio input and output. Some smartphones include similar but smaller input and output elements. Tablets and other types of smartphones utilize touch sensitive display screens, instead of separate keyboard and cursor control elements. The hardware elements, operating systems and programming languages of such user terminal devices also are conventional in nature.

Hence, aspects of the methods of remote device diagnostics outlined above may be embodied in programming. Program aspects of the technology may be thought of as “products” or “articles of manufacture” typically in the form of executable code and/or associated data that is carried on or embodied in a type of machine readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the MNO into the computer platform of the backend system that will be the DM server or the RDD server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the remote device diagnostics, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method, comprising:
in response to identifying a mobile device to a customer service system, querying a device management client on the identified mobile device to determine if the mobile device supports device management;
based on the response to the query, establishing a connection with a selected one of a first server of the customer service system and a second server of the customer service system, wherein the first server has diagnostic capabilities different from the diagnostic capabilities of the second server; and
in response to the establishment of the connection to the selected server, presenting in a user interface of a customer service representative terminal of the customer service system a portrayal of device information and device parameters of the identified mobile device according to a capability of the respective server to interact with the identified mobile device,
wherein the portrayed device information is different depending on whether the selected server is the first server or the second server.

2. The method of claim 1, wherein:
the first server is a remote device diagnostics server having a connection with a diagnostic application on the identified mobile device,
the connection is an over-the-air connection, and
information is exchanged over the connection between the diagnostic application and the remote device diagnostics server.

3. The method of claim 2, further comprising:
in response to the connection with the diagnostics application on the identified mobile device, disabling options in the customer service representative user interface for configuring the device parameters of the identified mobile device.

4. The method of claim 2, further comprising:
requesting state information of the identified mobile device from the diagnostic application on the mobile device; and
upon receiving the requested state information, presenting the requested state information in a reduced feature customer service representative user interface,
wherein the presented state information is unmodifiable through the reduced feature customer service representative user interface.

5. The method of claim 1, wherein:
the second server is a device management server having a connection to a device management client on the identified mobile device,
the connection is an over-the-air connection, and
information is exchanged over the connection between the device management client and the device management server.

6. The method of claim 5, further comprising:
authenticating the device management client as being authorized to interact with the device management server;
upon a successful authentication of the device management client, obtaining values for a predefined set of parameters that identify features supported by the identified management client; and
presenting the identified features in a full featured customer service representative user interface that allows the customer service representative to modify the parameter values of the identified features.

7. The method of claim 1, further comprising:
receiving a registration request from the identified mobile device, the registration request having device information including one or more of a mobile device number, a mobile equipment identifier, an international mobile station equipment identity, an international mobile subscriber identity, an integrated circuit card identifier, a make, a model, a device diagnostic application version, an operating system version, or a firmware version of the identified mobile device;
mapping the identified mobile device information to a level of device management support that the identified mobile device is capable of providing via the device management client; and
storing the mapping and the device information in a database.

8. The method of claim 7, wherein the mapping is a comparison of the device information in the request to a table indicating an open mobile alliance device management level of support that the identified mobile device is able to provide to a customer service system.

9. The method of claim 7, further comprising:
providing an indication to the user interface of the customer service representative table that the identified mobile device has been registered with the customer service center based on information retrieved from the database.

10. A system, comprising:
a call service center server configured to receive calls requesting customer service for a mobile device, wherein the mobile device is associated with a customer placing the received call;
a customer service terminal coupled to the call service center server including a user interface for a customer service representative;
a device management server coupled to the call center server and configured to communicate with the customer service terminal and with the mobile device, wherein the device management server communicates with a diagnostics application executing on the mobile device via an over-the-air connection;
a remote device diagnostics server coupled to the call center server and configured to communicate with the customer service terminal; and
a processor, coupled to the customer service terminal, wherein the processor is configured as the call service center server to perform a remote device diagnostic functions, including functions to:
in response to receiving an identification of a first mobile device, querying a device management client on the identified mobile device to determine if the mobile device supports device management;
based on the response to the query indicating that device management is unsupported by the first mobile device, establish a connection with the remote device diagnostics server;
obtaining from the remote diagnostics server, mobile device information and mobile device parameters of the mobile device, wherein the remote diagnostics server establishes a connection between the remote device diagnostics server and a diagnostic application on the identified first mobile device, wherein the established connection is an over-the-air connection, and information is exchanged over the established connection between the diagnostic application and the remote device diagnostics server;
in response to the establishment of the connection to the remote device diagnostics server, present in a reduced feature user interface of the customer service representative terminal a portrayal of device information and device parameters of the identified first mobile device, wherein the reduced feature user interface presents device parameters unmodifiable via the user interface;
in response to identifying a second mobile device to the customer service system, query a device management client on the identified second mobile device to determine if the identified second mobile device supports device management;
based on the response to the query indicating that device management is supported by the mobile device, establish a connection between the device management server and a device management client on the identified second mobile device, wherein the established connection is an over-the-air connection, and information is exchanged over the established connection between the device management client and the device management server; and
in response to the establishment of the connection to the device management server, present in a full featured user interface of a customer service representative terminal a portrayal of device information and device parameters of the identified second mobile device according to a capability of the identified second mobile device to interact with the remote device diagnostics server, wherein the full featured user interface presents device parameters of the identified second mobile device modifiable via the user interface.

11. The system of claim 10, wherein the processor is further configured to perform functions, including functions to:
request state information of the identified first mobile device from the diagnostic application on the mobile device; and
upon receiving the requested state information, present the requested state information in a customer service representative user interface, wherein the customer service representative user interface is a reduced feature user interface that prevents a customer service representative from remotely reconfiguring parameters on the identified first mobile device.

12. The system of claim 11, wherein the processor is further configured to perform functions, including functions to:
authenticate the device management client on the identified second mobile device as being authorized to interact with the device management server;
upon a successful authentication of the device management client, obtain values for a predefined set of parameters that identify features supported by the identified management client of the identified second mobile device; and
present the identified features in a full featured customer service representative user interface that allows the customer service representative to modify the parameter values of the identified features.

13. The system of claim 10, wherein the processor is further configured to perform functions, including functions to:
receive a registration request from the identified second mobile device, the registration request having device information including one or more of mobile device number, the mobile equipment identifier, the international mobile station equipment identity, international mobile subscriber identity, integrated circuit card identifier, make, model, device diagnostic application version, operating system version, and firmware version of the identified mobile device;
map the identified mobile device information to a level of device management support that the identified mobile device is capable of providing via the device management client; and
store the mapping of the identified mobile device information and the device information in a database.

14. The system of claim 13, wherein the mapping is a comparison of the device information in the request to a table indicating an open mobile alliance device management level of support that the identified mobile device is able to provide to a customer service system.

15. The system of claim 13, wherein the processor is further configured to perform functions, including functions to:
providing an indication that the identified mobile device has been registered with the customer service center.

16. A mobile device, comprising:
a radio frequency transceiver;
a memory storing executable program instructions of a device diagnostics application and a device management client;
a processor, wherein the processor is configured to perform functions, including functions to:
in response to a pre-defined event related to an operation of the mobile device, activate the device diagnostics application;
establish an over-the-air connection with a customer service system via the radio frequency transceiver;
send a registration request including one or more of a mobile device number, a mobile equipment identifier, an international mobile station equipment identity, an international mobile subscriber identity, an integrated circuit card identifier, a mobile device make, a mobile device model, a device diagnostic application version, an operating system version value, and a firmware version value to the customer service system;
in response to the sent registration request, receive an indication that the mobile device has been successfully registered with the customer service system; and
disconnect from the established over-the-air connection with the customer service system.

17. The mobile device of claim 16, wherein the processor is further configured to perform further functions, including functions to:
establish a connection over-the-air connection a customer service system; and
in response to a query from the customer service system, provide information via the device diagnostics related to device management capabilities of the mobile device.

18. The mobile device of claim 16, wherein the processor is further configured to perform further functions, including functions to:
receive an open management alliance device management configuration parameter modification command from a customer service representative via the over-the-air connection with the customer service system; and
in response to the open management alliance device management configuration parameter modification command, modify, via the device management client, the configuration parameter.

19. The mobile device of claim 18, wherein the processor is further configured to perform further functions, including functions to:
prior to modifying the configuration parameter, present a prompt on a display device of the mobile device requesting confirmation of the modification of the configuration parameter.

20. The mobile device of claim 16, wherein the processor is further configured to perform further functions, including functions to:
receive, via an over-the-air connection with the customer service system and through an operating system open application programming interface, a request for device information; and
in response to the request, provide, by the device diagnostics application via the operating system open application programming interface, the device information.
